(19) United States
(12) Patent Application Publication
(10) Pub. No.: US 2017/0357545 A1
(43) Pub. Date: Dec. 14, 2017

(54) INFORMATION PROCESSING APPARATUS AND INFORMATION PROCESSING METHOD

(71) Applicant: Fujitsu Limited, Kawasaki-shi (JP)

(72) Inventor: Shinya Hashiguchi, Kawasaki (JP)

(73) Assignee: Fujitsu Limited, Kawasaki-shi (JP)

(21) Appl. No.: 15/688,350

(22) Filed: Aug. 28, 2017

Related U.S. Application Data
(63) Continuation of application No. PCT/JP2015/056347, filed on Mar. 4, 2015.

(51) Int. Cl. G06F 11/07; G06F 13/42

(52) U.S. Cl. CPC G06F 11/0778; G06F 13/4239

(57) ABSTRACT

An information processing apparatus includes a processor, a memory, a memory controller, and a storage. The memory serves as a main memory of the processor. The memory controller controls a first access from the processor to the memory, a second access to the memory that is performed without being synchronized with the first access, and processing related to memory dump acquisition. The storage stores, upon performing the second access, a memory dump of data stored in the memory, according to an instruction given by the memory controller.

### CROSS-REFERENCE TO RELATED APPLICATION

This application is a continuation application of International Application PCT/JP 2015/056347 filed on Mar. 4, 2015 and designated the U.S., the entire contents of which are incorporated herein by reference.

### FIELD

The embodiments discussed herein are related to a memory dump.

### BACKGROUND

A computer system stores data of a main memory in other storage when a failure has occurred in the system. The data stored in the other storage is called a memory dump. The acquisition of a memory dump in a system in operation is an effective method, for example, when a cause of a system failure is analyzed.

In recent years, there has emerged a server with a main memory having a capacity on the order of terabytes (TB), and it takes a long time to perform processing of acquiring a memory dump of the main memory in a system having such a configuration. When a failure has occurred in the system, the processing of acquiring a memory dump is performed and the operation of the system is stopped while the processing is being performed. Preferably, the operation of a system will be stopped only for a short time period after the occurrence of a failure and the operation of the system can be restarted quickly.

A method for backing up a memory dump that includes saving a memory dump in an external portable medium, such as a magnetic tape, in a state in which there is no access after a system is restarted is known (see, for example, Patent Document 1).

A usually-used region and a reserve region are set in advance in a main memory. When a failure has occurred, the reserve region is operated as a used area so as to acquire a memory dump of the usually-used region without affecting the system operation (see, for example, Patent Document 2).

Patent document 1: Japanese Laid-open Patent Publication No. 08-30492

Patent document 2: Japanese Laid-open Patent Publication No. 2004-280140

### SUMMARY

An information processing apparatus according to an aspect of the present invention includes a processor, a memory, a memory controller, and a storage. The memory serves as a main memory of the processor. The memory controller controls a first access from the processor to the memory, a second access to the memory that is performed without being synchronized with the first access, and processing related to memory dump acquisition. The storage stores, upon performing the second access, a memory dump of data stored in the memory, according to an instruction given by the memory controller.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing apparatus according to the present embodiment;

FIG. 2 illustrates an example of processing performed in a controller when a memory access is performed from a core to a main memory;

FIG. 3 illustrates an example of management information;

FIG. 4 illustrates an example of processing of acquiring a memory dump using scrubbing;

FIG. 5 illustrates an example of processing performed when updating is performed on the main memory during memory dump acquisition;

FIG. 6 illustrates an example of processing of acquiring a memory dump after a system failure has occurred;

FIG. 7 is a flowchart that illustrates the example of the processing performed in the controller when a memory access is performed from the core to the main memory;

FIG. 8A is a flowchart that illustrates the example of the processing of acquiring a memory dump using scrubbing;

FIG. 8B is the flowchart that illustrates the example of the processing of acquiring a memory dump using scrubbing;

FIG. 9 is a flowchart that illustrates the example of the processing performed when updating is performed on the main memory during memory dump acquisition; and

FIG. 10 is a flowchart that illustrates the example of the processing of acquiring a memory dump after a system failure has occurred.

### DESCRIPTION OF EMBODIMENTS

Embodiments will now be described in detail with reference to the drawings.

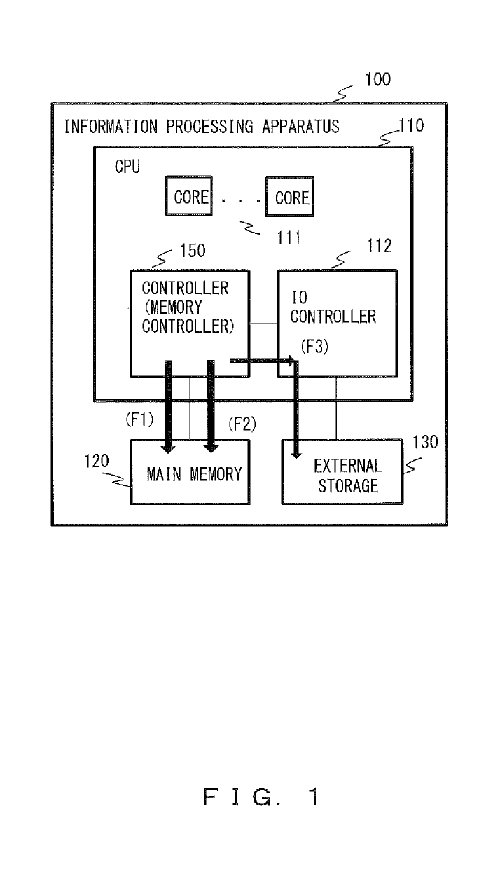

FIG. 1 illustrates an example of an information processing apparatus according to the present embodiment. An information processing apparatus 100 includes a central processing unit (CPU) 110, a main memory 120, and an external storage 130. The main memory 120 serves as a main memory of the CPU 110. The external storage 130 is a storage that stores a memory dump of the main memory 120. The external storage 130 may be, for example, a hard disc drive (HDD) or a solid-state drive (SSD).

The CPU 110 includes cores 111, a controller 150, and an IO controller 112. The core 111 refers to a processor core and includes, for example, a logic circuit and a cache for performing operational processing. The controller 150 refers to a memory controller. The controller 150 controls a memory access from the core 111 to the main memory 120. The IO controller 112 is an interface that writes a memory dump into the external storage 130.

The controller 150 controls a memory access from the core 111 to the main memory 120 (F1). Further, the controller 150 performs a memory access to the main memory 120 (F2) by a memory patrol independently of the memory access from the core 111 to the main memory 120 (F1). The memory patrol (F2) is not synchronized with the memory access from the core 111 to the main memory 120 (F1). Thus, access such as the memory patrol (F2) is also referred to as an asynchronous access (F2) that is not synchronized with the memory access from the core 111 to the main memory 120 (F1). The memory patrol (F2) is, for example, a memory patrol scrubbing. The memory patrol scrubbing is hereinafter referred to as “scrubbing”.

The scrubbing (F2) includes accessing memory regions in the main memory 120 in order of memory address so as to read data. The scrubbing (F2) includes correcting a detected correctable 1-bit error so as to perform write back when the correctable 1-bit error is detected upon reading the data. When no error is detected by performing scrubbing, write back is not performed. The scrubbing (F2) is performed by accessing all of the memory addresses comprehensively in order to check the entirety of data in the main memory 120.

The information processing apparatus 100 according to the present embodiment acquires a memory dump (F3) using processing of, for example, reading or writing included in a memory patrol (F2) performed by the controller 150. For example, the scrubbing (F2) includes reading the entirety of the data in the main memory 120 comprehensively. The controller 150 of the information processing apparatus 100 is able to acquire a memory dump efficiently using the data read (or corrected in the case of a 1-bit error) by performing scrubbing (F2) as a memory dump. The controller 150 stores the acquired memory dump in the external storage 130. In other words, the asynchronous access (F2) is performed parallel to the memory access from the core 111 to the main memory 120 (F1). A memory dump is written into the external storage 130 using the asynchronous access (F2), so as to acquire the memory dump in a background in which the memory access from the core 111 to the main memory 120 (F1) is performed.

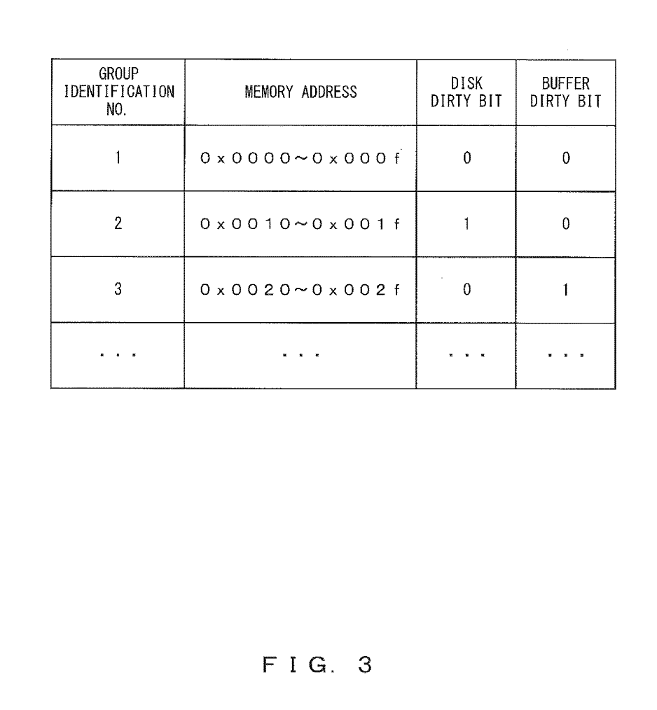

The controller 150 stores management information that manages whether there is a difference in data between a memory dump stored in the external storage 130 and data in the main memory 120 (described later in FIG. 3). In other words, the management information is information that indicates whether the memory dump stored in the external storage 130 is the newest data in the main memory 120. When there occurs a system failure, the controller 150 reads the management information and acquires a memory address of a piece of data of the main memory 120 that is a difference between the main memory 120 and the memory dump stored in the external storage 130. The controller 150 specifies the memory address of the piece of different data and acquires a memory dump.

As described above, in the information processing apparatus 100 according to the present embodiment, the controller 150 regularly performs scrubbing (F2) on the main memory 120 parallel to a memory access from the core 111 to the main memory 120 (F1) during a time period in which there occurs no failure in a system. The controller 150 acquires a memory dump using data read by performing scrubbing (F2). When a failure has occurred in the system, the information processing apparatus 100 acquires a memory dump of a piece of data in the main memory 120, the piece of data being a difference between the main memory 120 and the acquired memory dump. A data amount to be processed can be reduced by acquiring a memory dump of a portion of data in the main memory 120, not a memory dump of the entirety of the data, after the occurrence of a failure in the system. This results in also reducing the time to perform processing of acquiring a memory dump after the occurrence of the failure.

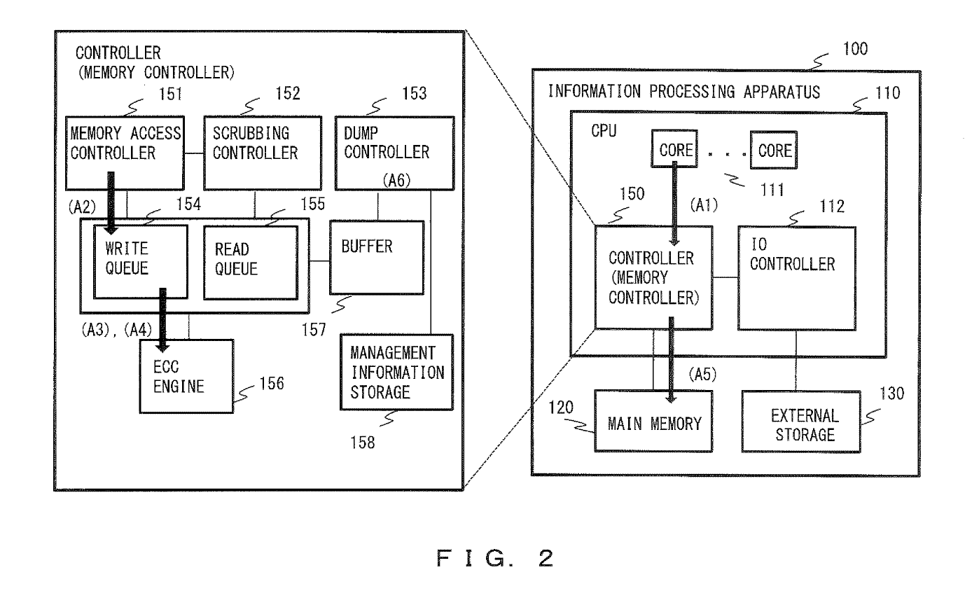

FIG. 2 illustrates an example of processing performed in the controller when a memory access is performed from the core to the main memory. For the same components as those in FIG. 1, like reference numbers are used in FIG. 2. The controller 150 includes a memory access controller 151, a scrubbing controller 152, a dump controller 153, a write queue 154, a read queue 155, an ECC engine 156, a buffer 157, and a management information storage 158. The memory access controller 151 controls a memory access from the core 111 to the main memory 120. The scrubbing controller 152 performs a control to perform scrubbing on the main memory 120 regularly. The dump controller 153 controls processing of acquiring a memory dump of data in the main memory 120. The write queue 154 stores an instruction to write into the main memory 120 from the memory access controller 151. The write instruction includes data to be written into the main memory 120, a memory address of a write destination in the main memory 120, and type identification information. The type identification information is, for example, information “00” that indicates an access instruction from the memory access controller 151, information “01” that indicates an access instruction from the scrubbing controller 152, or information “10” that indicates an access instruction other than “00” or “01”. It is sufficient if the type identification information makes it possible to identify a type of access instruction.

The read queue 155 temporarily stores data read by the memory access controller 151 from the main memory 120, and data read by the scrubbing controller 152 from the main memory 120, when scrubbing is performed. The ECC engine 156 adds an ECC bit to write data. Further, the ECC engine 156 corrects a bit error when the bit error is detected. From among the data stored in the read queue 155, the buffer 157 stores the data read by the scrubbing controller 152 from the main memory 120 when scrubbing is performed. The management information storage 158 stores management information. The management information includes information for managing whether there is a difference in data between a memory dump stored in the external storage 130 and data in the main memory 120.

The example of processing performed in the controller 150 when a memory access is performed from the core 111 to the main memory 120 according to the present embodiment is described below.

(A1) The core 111 makes a write request to the controller 150. The write request includes data to be written into the main memory 120 and a memory address of a write destination (a memory address in the main memory 120).
(A2) The memory access controller 151 adds the type identification information “00” to the write request. The memory access controller 151 stores the write request and the type identification information in the write queue 154.
(A3) When the write request and the type identification information are at the head of the write queue 154, the memory access controller 151 reads the data to be written into the main memory 120 from the write queue 154.
(A4) The ECC engine 156 adds an ECC bit to the data to be written into the main memory 120.
(A5) The controller 151 specifies the memory address of the write destination in the main memory 120, and writes, into the main memory 120, the data to be written into the main memory 120.
(A6) The dump controller 153 updates the management information stored in the management information storage 158.

In the information processing apparatus 100 of the present embodiment manages the main memory 120 by dividing for each predetermined data size. A management unit of the main memory 120 that is the predetermined data size is referred to as a “group”. The management information stored in the management information storage 158 includes, for each group, information that indicates whether the data of the memory dump is the newest data. When the memory dump stored in the external storage 130 is the newest data, the dump controller 153 sets, in the management information, information indicating that “a memory dump is not dirty (the newest data)” with respect to a group to which the data of the memory dump belongs. On the other hand, when the memory dump stored in the external storage 130 is not the newest data, the dump controller 153 sets, in the management information, information indicating that “a memory dump is dirty (not the newest data)” with respect to the group to which the data of the memory dump belongs. In the process of (A6), the dump controller 153 sets, in the management information, information indicating that the data in the main memory 120 has been updated and the memory dump is not newest (dirty) with respect to a group including the memory address of the write destination in the main memory 120.

FIG. 3 illustrates an example of management information. The management information includes information such as a group identification number, a memory address, a disk dirty bit, and a buffer dirty bit. The group identification number is information used to identify a group that is a management unit for data in the main memory 120. The memory address is a memory address group included in a group that corresponds to the group identification number. For example, a group whose group identification number is 1 includes the memory addresses “0x0000” to “0x000f”. A group whose group identification number is 2 includes the memory addresses “0x0010” to “0x001f”. A group whose group identification number is 3 includes the memory addresses “0x0020” to “0x002f”. The example of the management information illustrated in FIG. 3 is not intended to limit the data size that is a management unit for each group.

The disk dirty bit is information that indicates, for each group, whether a memory dump stored in the external storage 130 is the newest data in the main memory 120. In other words, the disk dirty bit is information that indicates whether there is a difference between the memory dump stored in the external storage 130 and data in the main memory 120. When the memory dump stored in the external storage 130 is the newest data in the main memory 120, “0”, which indicates “not dirty”, is set in the management information. When the memory dump stored in the external storage 130 is not the newest data in the main memory 120, “1”, which indicates “dirty”, is set in the management information. In the example of the management information illustrated in FIG. 3, “1”, which indicates that data (a memory dump) in the group of the group identification number 2 is dirty (not newest), is set for the group. Thus, when there occurs a system failure, the dump controller 153 acquires information on a group for which “1” is set in the disk dirty bit in the management information stored in the management information storage 158, so as to acquire a memory dump of the acquired group.

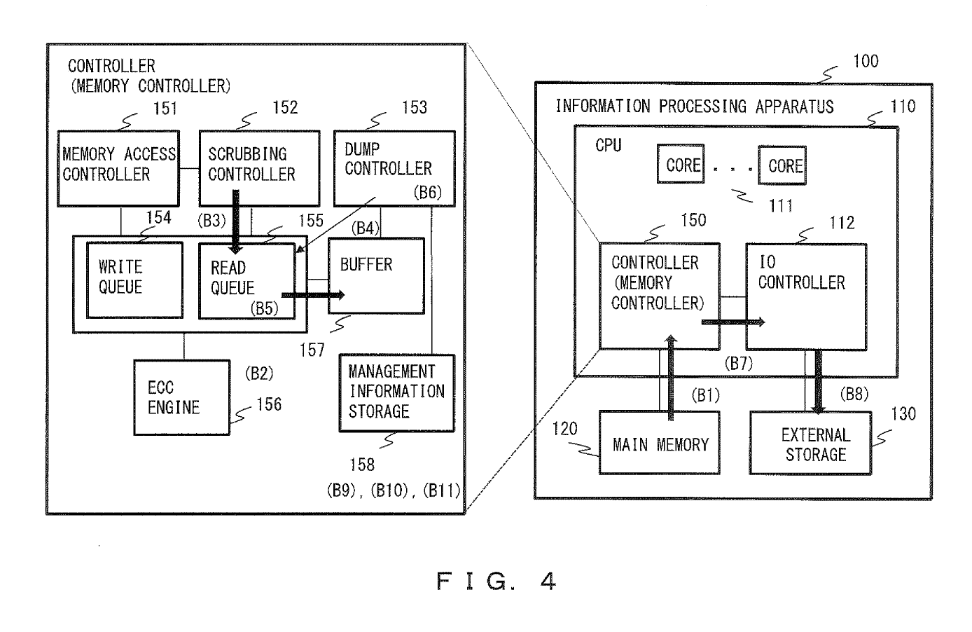

The buffer dirty bit is information that indicates, for each group, whether there is a difference between data in the main memory 120 and data stored in the buffer 157. The data stored in the buffer 157 is temporarily stored by the dump controller 153 when the dump controller 153 acquires a memory dump, and is data before the memory dump is stored in the external storage 130. In other words, the buffer dirty bit is information that indicates whether the data in the main memory 120 has been updated during processing of storing a memory dump in the external storage 130 and the memory dump is no longer the newest data. When the data in the main memory 120 has not been updated during the processing of storing a memory dump in the external storage 130, “0” indicating “not dirty” (the memory dump is newest) is set in the management information. When the data in the main memory 120 has been updated during the processing of storing a memory dump in the external storage 130, “1” indicating “dirty” (the memory dump is not newest) is set in the management information. In the example of the management information illustrated in FIG. 3, “1” indicating “dirty” (the memory dump is not newest) is set for a group of the group identification number 3. When a memory dump acquired during scrubbing is being performed, the dump controller 153 sets “1”, which is information indicating “dirty” for the buffer dirty bit, to be “1”, which is information indicating “dirty” for the disk dirty bit (this will be described in detail in FIG. 4).

When there occurs a system failure, the dump controller 153 acquires a group for which “1” indicating “dirty” is set in the disk dirty bit in the management information, so as to acquire a memory dump of the acquired group.

The memory dump of data in the main memory 120 may be acquired for each memory address. When the memory dump of data in the main memory 120 is not acquired for each group, the management information does not need to include a group or a buffer dirty bit. When the memory dump of data in the main memory 120 is not acquired for each group, the controller 150 illustrated in FIG. 2 does not need to include the buffer 157.

FIG. 4 illustrates an example of processing of acquiring a memory dump using scrubbing. For the same components as those in FIG. 2, like reference numbers are used in FIG. 4. The example of the processing of acquiring a memory dump using scrubbing is described below.

(B1) The scrubbing controller 152 specifies a memory address for which scrubbing is to be performed, and reads data of the specified memory address from the main memory 120.
(B2) The ECC engine 156 checks the ECC bit of the read data, and makes a correction when there is a 1-bit error.
(B3) The scrubbing controller 152 adds the type identification information “01” indicating an access instruction given by the scrubbing controller 152 to the read data or the corrected data. The scrubbing controller 152 stores the read data or the corrected data and the type identification information in the read queue 155.
(B4) The dump controller 153 checks the read queue 155 regularly and determines whether the type identification information is “01” (whether the type identification information is data read by performing scrubbing). The dump controller 153 includes, for example, a circuit that identifies type identification information.
(B5) The dump controller 153 stores, in the buffer 157, data to which the type identification information “01” is added.
(B6) The dump controller 153 determines whether pieces of data that correspond to all of the memory addresses of a group are stored in the buffer 157. In other words, the processes of (B1) to (B5) are performed for each of the memory addresses specified by performing scrubbing. As a result of performing the processes of (B1) to (B5), the dump controller 153 determines whether data corresponding to the data size of the group has been stored in the buffer 157.
(B7) When data corresponding to the group has been stored in the buffer 157, the dump controller 153 gives an instruction to the IO controller 112 to write the data into the external storage 130.
(B8) According to the instruction, the IO controller 112 reads the data from the buffer 157 and writes the data into the external storage 130. The data written into the external storage 130 is a memory dump.
(B9) The dump controller 153 reads the management information and determines whether “1” indicating “dirty” (the memory dump is not newest) is set in the buffer dirty bit which corresponds to the group written into the external storage 130. In other words, the dump controller 153 determines whether data has been updated on the side of the main memory 120 during the processes of (B1) to (B8) and whether the memory dump written into the external storage 130 in the processes of (B7) and (B8) is no longer newest.
(B10) When “1” indicating “dirty” (the memory dump is not newest) is set in the buffer dirty bit, in the management information, which corresponds to the group written into the external storage 130, the dump controller 153 sets “1” in the disk dirty bit of the same group. When “0” indicating “not dirty” is set in the buffer dirty bit which corresponds to the group written into the external storage 130, the dump controller 153 sets “0” in the disk dirty bit of the same group.
(B11) The dump controller 153 sets “0” indicating “not dirty” (the memory dump is newest) in the buffer dirty bit, in the management information, which corresponds to the group written into the external storage 130.

As described above, the controller 150 performs scrubbing on the main memory 120 regularly. The controller 150 can acquire a memory dump using data read by performing scrubbing. In other words, an asynchronous access (F2) is performed parallel to a memory access from the core 111 to the main memory 120 (F1). A memory dump is written into the external storage 130 using the asynchronous access (F2) so as to acquire the memory dump in a background in which the memory access from the core 111 to the main memory 120 (F1) is performed.

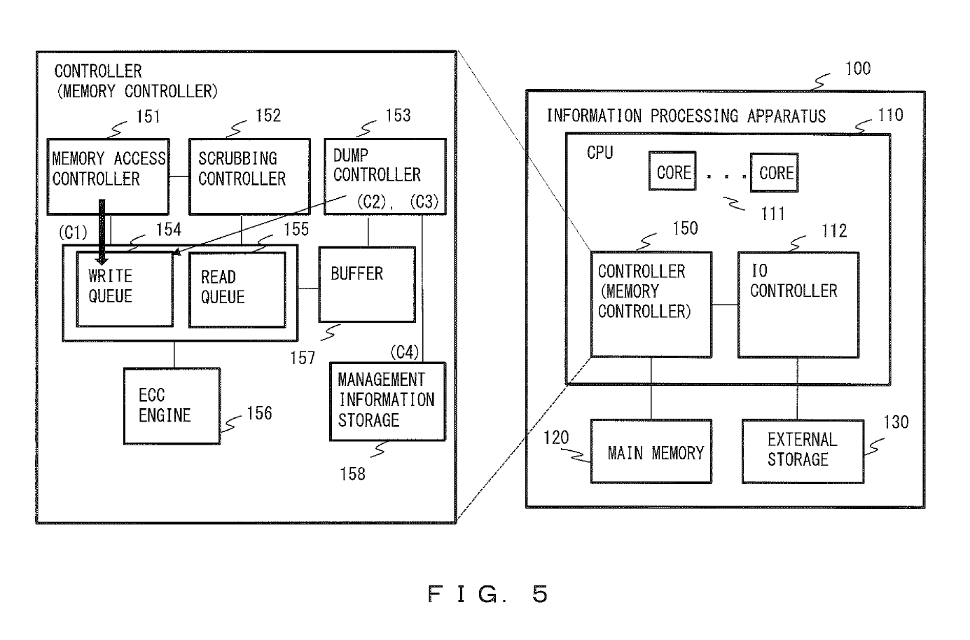

FIG. 5 illustrates an example of processing performed when updating is performed on the main memory during memory dump acquisition. For the same components as those in FIG. 3, like reference numbers are used in FIG. 5. The example of processing performed when updating is performed in the main memory during memory dump acquisition is described below.

(C1) The memory access controller 151 adds the type identification information “00” to a write request. The memory access controller 151 stores the write request and the type identification information in the write queue 154.
(C2) The dump controller 153 checks the write queue 154 regularly and determines whether data whose type identification information is “00” is included. The dump controller 153 includes, for example, a circuit that identifies type identification information.
(C3) The dump controller 153 determines whether a memory address that is the same as the memory address of a write destination of the data whose type identification information is “00” is included in data held by the buffer 157 or the read queue 155.
(C4) When the memory address that is the same as the memory address of the write destination of the data whose type identification information is “00” is included in the data held by the buffer 157 or the read queue 155, the dump controller 153 updates the management information. Specifically, the dump controller 153 sets “1” indicating that the memory dump is dirty (not newest) in the buffer dirty bit which corresponds to a group that includes the memory address of the write destination of the data whose type identification information is “00”.

According to the processes of (C1) to (C4), information indicating that the memory dump is dirty (not newest) is stored in management information when the data in the main memory 120 is updated during memory dump acquisition.

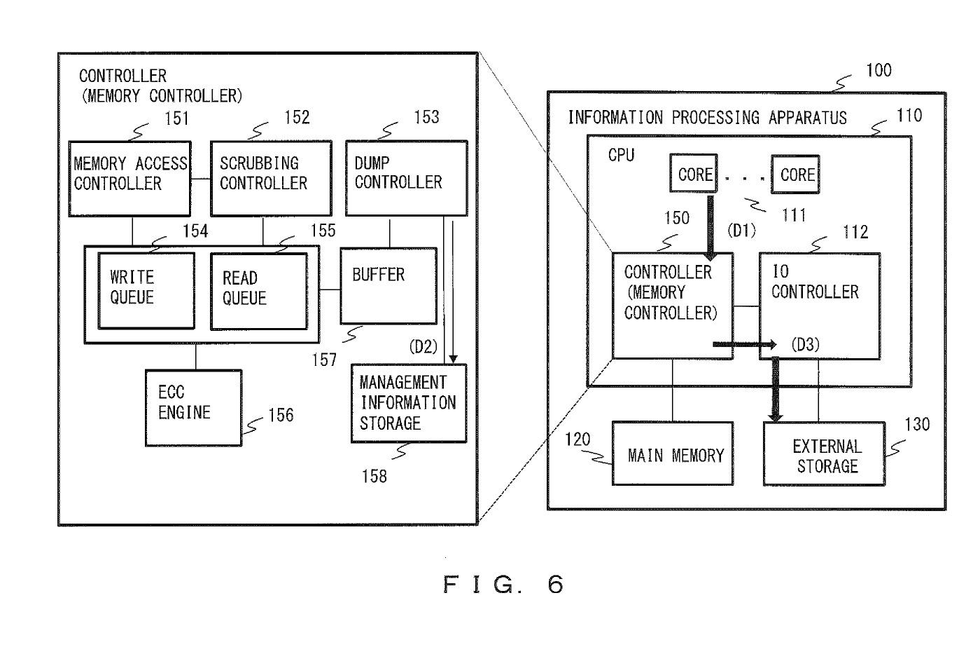

FIG. 6 illustrates an example of processing of acquiring a memory dump after a system failure has occurred. For the same components as those in FIG. 2, like reference numbers are used in FIG. 6. The example of the processing of acquiring a memory dump after a system failure has occurred is described below.

(D1) When a system failure has occurred, the controller 150 receives, from an operation system (OS) or firmware, an instruction to acquire a memory dump.
(D2) The dump controller 153 determines whether there exists a group for which “1” indicating that the memory dump is dirty is set in the disk dirty bit in the management information.
(D3) The dump controller 153 acquires, from the main memory 120, a memory dump of the group for which “1” is set in the disk dirty bit in the management information, and stores the memory dump in the external storage 130.
(D4) The controller 150 restarts the information processing apparatus 100.

As described above, in the information processing apparatus 100 according to the present embodiment, the controller 150 regularly performs scrubbing on the main memory 120 during a time period in which there occurs no failure in a system. The controller 150 acquires a memory dump using data read by performing scrubbing. When a failure has occurred in the system, the information processing apparatus 100 acquires a memory dump of a piece of data in the main memory 120, the piece of data being a difference between the main memory 120 and the acquired memory dump. A data amount to be processed can be reduced by acquiring a memory dump of a portion of data in the main memory 120, not a memory dump of the entirety of the data, after the occurrence of a failure in the system. This results in also reducing the time to perform processing of acquiring a memory dump after the occurrence of the failure.

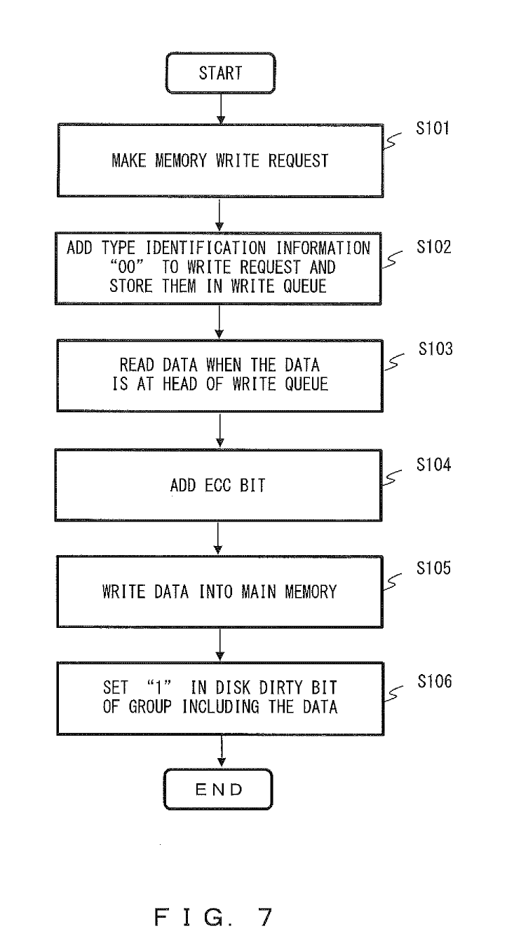

FIG. 7 is a flowchart that illustrates the example of the processing performed in the controller when a memory access is performed from the core to the main memory. The core 111 makes a write request to the controller 150 (Step S101). The memory access controller 151 adds the type identification information “00” to the write request and stores the write request and the type identification information in the write queue 154 (Step S102). When the write request and the type identification information are at the head of the write queue 154, the memory access controller 151 reads the data to be written into the main memory 120 from the write queue 154 (Step S103). The ECC engine 156 adds an ECC bit to the data to be written into the main memory 120 (Step S104). The controller 151 specifies a memory address of a write destination in the main memory 120, and writes, into the main memory 120, the data to be written into the main memory 120 (Step S105). The dump controller 153 sets “1” indicating that the memory dump is dirty (not newest) in the disk dirty bit in the management information with respect to a group including the memory address of the write destination in the main memory 120 (Step S106).

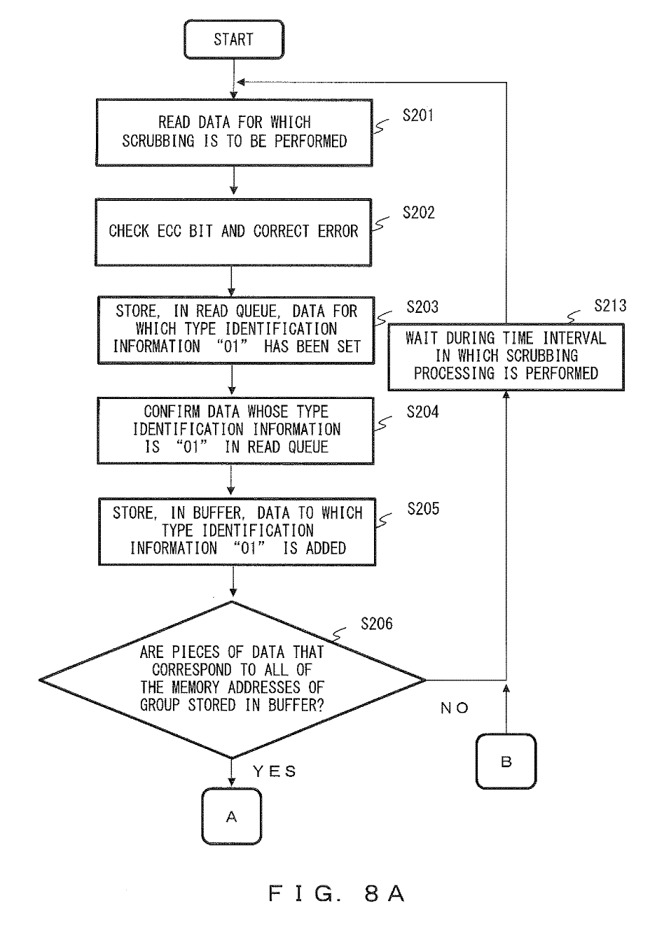

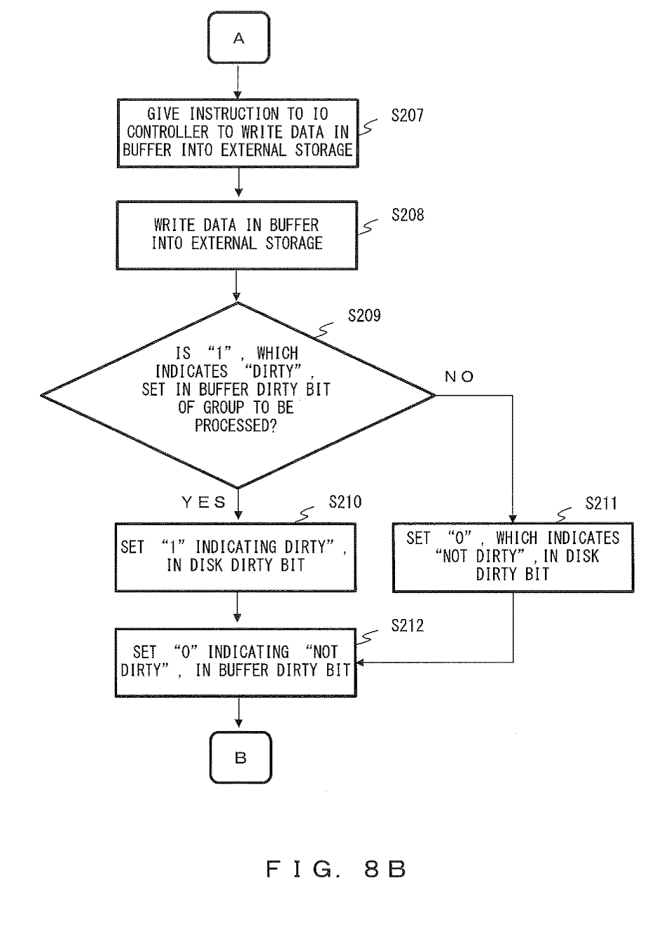

FIGS. 8A and 8B are a flowchart that illustrates the example of the processing of acquiring a memory dump using scrubbing. The scrubbing controller 152 specifies a memory address for which scrubbing is to be performed, and reads data of the specified memory address from the main memory 120 (Step S201). The ECC engine 156 checks the ECC bit of the read data, and makes a correction when there is a 1-bit error (Step S202). The scrubbing controller 152 adds the type identification information “01” indicating an access instruction given by the scrubbing controller 152 to the read data or the corrected data. The scrubbing controller 152 stores the read data or the corrected data and the type identification information in the read queue 155 (Step S203). The dump controller 153 checks the read queue 155 regularly and confirms data whose type identification information is “01” (data that is data read by performing scrubbing) (Step S204). The dump controller 153 stores, in the buffer 157, the data to which the type identification information “01” is added (Step S205). The dump controller 153 determines whether pieces of data that correspond to all of the memory addresses of a group are stored in the buffer 157 (Step S206). When not all of the pieces of data that correspond to all of the memory addresses of the group are stored in the buffer 157 (NO in Step S206), the controller 150 waits during a time interval in which scrubbing processing is performed (Step S213).

When all of the pieces of data that correspond to all of the memory addresses of the group are stored in the buffer 157 (YES in Step S206), the dump controller 153 gives an instruction to the IO controller 112 to write the data into the external storage 130 (Step S207). According to the instruction, the IO controller 112 reads the data from the buffer 157 and writes the data into the external storage 130 (Step S208). The dump controller 153 reads the management information and determines whether “1” indicating “dirty” is set in the buffer dirty bit which corresponds to the group written into the external storage 130 (Step S209).

When “1” indicating “dirty” is set in the buffer dirty bit (YES in Step S209), the dump controller 153 sets “1” indicating “dirty” in the disk dirty bit (Step S210). When “1” indicating “dirty” is not set in the buffer dirty bit (NO in Step S209), the dump controller 153 sets “0” indicating “not dirty” in the disk dirty bit (Step S211). The dump controller 153 sets “0” indicating “not dirty” (the memory dump is newest) in the buffer dirty bit, in the management information, which corresponds to the group written into the external storage 130 (Step S212). The controller 150 waits during a time interval in which scrubbing processing is performed (Step S213). The controller 150 repeats the processes of and after Step S201 after the process of Step S213 is performed.

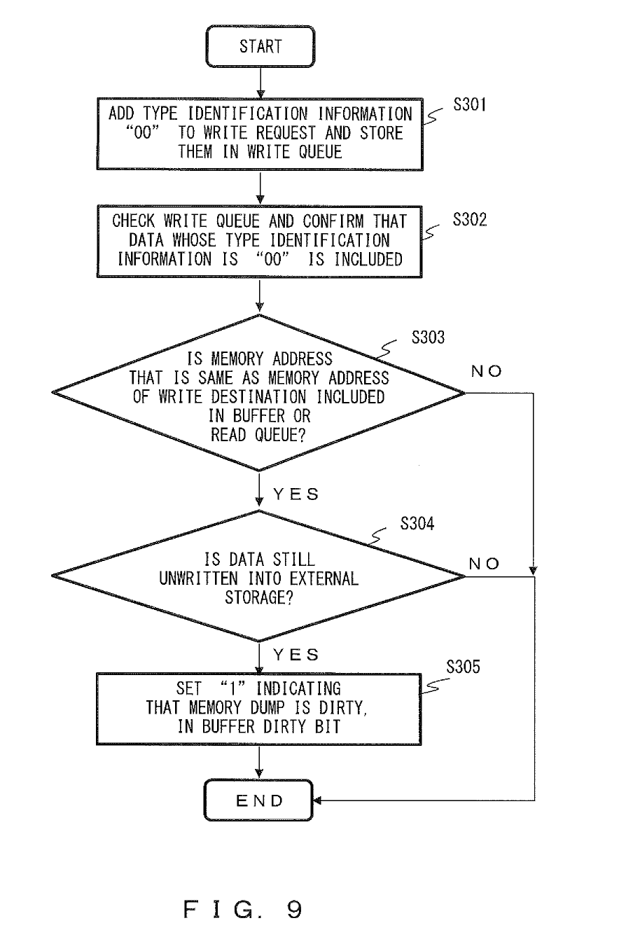

FIG. 9 is a flowchart that illustrates the example of the processing performed when updating is performed on the main memory 120 during memory dump acquisition. When writing into the main memory is performed during memory dump acquisition, the controller 150 performs the processing of the flowchart illustrated in FIG. 9 in addition to the processing of the flowchart illustrated in FIGS. 8A and 8B.

The memory access controller 151 adds the type identification information “00” to a write request. The memory access controller 151 stores the write request and the type identification information in the write queue 154 (Step S301). The dump controller 153 checks the write queue 154 regularly and confirms that data whose type identification information is “00” is included (Step S302). The dump controller 153 determines whether a certain memory address that is the same as the memory address of a write destination of the data whose type identification information is “00” is included in data held by the buffer 157 or the read queue 155 (Step S303). When the data that includes the certain memory address is held by the buffer 157 or the read queue 155 (YES in Step S303), the dump controller 153 determines whether the data is still unwritten into the external storage (Step S304). When the data is still unwritten into the external storage (YES in Step S304), the dump controller 153 sets “1” indicating that the memory dump is dirty in the buffer dirty bit (Step S305).

When the data that includes the certain memory address that is the same as the memory address of the write destination is not held by the buffer 157 or the read queue 155 (NO in Step S303), the controller 150 terminates the additional processing illustrated in FIG. 9 that is additionally performed during scrubbing processing. When the data has already been written into the external storage 130 (NO in Step S304), the controller 150 terminates the additional processing illustrated in FIG. 9 that is additionally performed during scrubbing processing. Likewise, when the process of Step S305 is terminated, the controller 150 terminates the additional processing illustrated in FIG. 9 that is additionally performed during scrubbing processing.

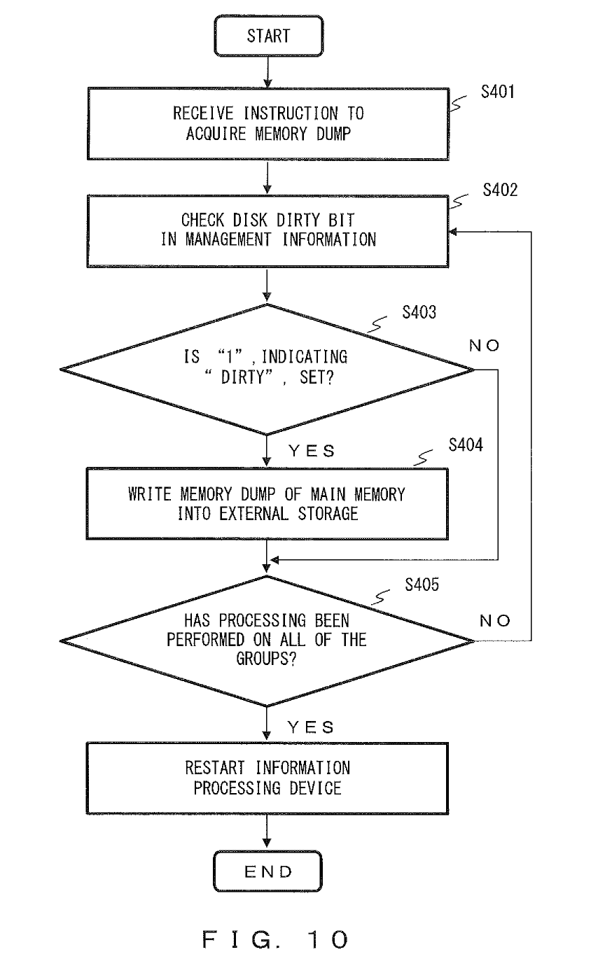

FIG. 10 is a flowchart that illustrates the example of the processing of acquiring a memory dump after a system failure has occurred.

When a system failure has occurred, the controller 150 receives, from an operating system (OS) or firmware, an instruction to acquire a memory dump (Step S401). The dump controller 153 checks a disk dirty bit of each group in the management information (Step S402). The dump controller 153 selects a group in the management information and determines whether “1” indicating “dirty” (the memory dump is not newest) is set in the disk dirty bit of the selected group (Step S403).

When the selected group is dirty (YES in Step S403), the dump controller 153 acquires a memory dump of the selected group and stores the memory dump in the external storage 130 (Step S404). The dump controller 153 determines whether the processes of and after Step 402 have been performed on all of the groups (Step S405). When the selected group is not dirty (NO in Step S403), the dump controller 153 performs the process of Step S405. When the processes of and after Step S402 have not been performed on all of the groups (NO in Step S405), the controller 150 repeats the processes of and after Step S402.

When the processes of and after Step S402 have been performed on all of the groups (YES in Step S405), the controller 150 restarts the information processing apparatus 100.

As described above, in the information processing apparatus 100 according to the present embodiment, the controller 150 regularly performs scrubbing (F2) on the main memory 120 parallel to a memory access from the core 111 to the main memory 120 (F1) during a time period in which there occurs no failure in a system. The controller 150 acquires a memory dump using data read by performing scrubbing (F2). When a failure has occurred in the system, the information processing apparatus 100 acquires a memory dump of a piece of data in the main memory 120, the piece of data being a difference between the main memory 120 and the acquired memory dump. A data amount to be processed can be reduced by acquiring a memory dump of a portion of data in the main memory 120, not a memory dump of the entirety of the data, after the occurrence of a failure in the system. This results in also reducing the time to perform processing of acquiring a memory dump after the occurrence of the failure.

All examples and conditional language provided herein are intended for the pedagogical purpose of aiding the reader in understanding the invention and the concepts contributed by the inventor to further the art, and are not to be construed as limitations to such specifically recited examples and conditions, nor does the organization of such examples in the specification related to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a processor;
a memory configured to serve as a main memory of the processor;
a memory controller configured to control a first access from the processor to the memory, a second access to the memory that is performed without being synchronized with the first access, and processing related to memory dump acquisition; and
a storage configured to store, upon performing the second access, a memory dump of data stored in the memory, according to an instruction given by the memory controller.

2. The information processing apparatus according to claim 1, wherein
when writing into data in the memory is performed due to the first access, the memory controller stores management information that manages a difference between a memory dump stored in the storage and the data in the memory, and
when there occurs a failure, the memory controller acquires a memory dump of apiece of different data in the memory on the basis of the management information, and stores the acquired memory dump in the storage.

3. The information processing apparatus according to claim 1, wherein
the second access is a memory patrol scrubbing.

4. The information processing apparatus according to claim 2, wherein
the memory controller manages, in the management information, the difference between the memory dump stored in the storage and the data in the memory using a dirty bit.

5. A semiconductor device comprising:
a processor core; and
a memory controller configured
to control a first access from the processor core to a memory which serves as a main memory of the processor core, a second access to the memory that is performed without being synchronized with the first access, and processing related to memory dump acquisition, and
to store in a storage, upon performing the second access, a memory dump of data stored in the memory.

6. The semiconductor device according to claim 5, wherein
when writing into data in the memory is performed due to the first access, the memory controller stores management information that manages a difference between a memory dump stored in the storage and the data in the memory, and
when there occurs a failure, the memory controller acquires a memory dump of apiece of different data in the memory on the basis of the management information, and stores the acquired memory dump in the storage.

7. The semiconductor device according to claim 5, wherein
the second access is a memory patrol scrubbing.

8. The semiconductor device according to claim 6, wherein
the memory controller manages, in the management information, the difference between the memory dump stored in the storage and the data in the memory using a dirty bit.

9. An information processing method comprising:
storing, by a memory controller, in an external storage, a memory dump of data stored in a main memory upon performing a second access to the main memory that is performed without being synchronized with a first access from a processor to the main memory, the main memory serving as a main memory of the processor.

10. The information processing method according to claim 9, wherein
when writing into data in the main memory is performed due to the first access, management information is stored that manages a difference between a memory dump stored in the external storage and the data in the main memory, and
when there occurs a failure, a memory dump of a piece of different data is acquired in the memory on the basis of the management information, and the acquired memory dump is stored in the external storage.

11. The information processing method according to claim 9, wherein
the second access is a memory patrol scrubbing.

12. The information processing method according to claim 10, wherein
the difference between the memory dump stored in the storage and the data in the memory is managed in the management information using a dirty bit.
